(19) United States
(12) Patent Application Publication
(10) Pub. No.: US 2017/0290429 A1
(43) Pub. Date: Oct. 12, 2017

(54) MECHANICALLY-STRETCHING DEVICE FOR AUTOMATIC FOLDING OF MOVABLE SOFA LEGS

(71) Applicant: Bruce HUANG, Jiangsu (CN)

(72) Inventors: Xiaowei Huang, Suzhou (CN); Xiaohong Li, Suzhou (CN); Haibo Wang, Suzhou (CN); Guoli Zou, Suzhou (CN); Linlin Wu, Suzhou (CN)

(73) Assignee: Remacro Machinery & Technology (Wujiang) Co, Ltd., Suzhou (CN)

(21) Appl. No.: 15/508,479

(22) PCT Filed: Aug. 20, 2015
(86) PCT No.: PCT/CN2015/087640

§ 371 Date: Mar. 2, 2017

(30) Foreign Application Priority Data
Sep. 3, 2014 (CN) 2014104450638

(51) Int. Cl. A47C 1/034; A61G 15/12

(52) U.S. Cl. CPC A47C 1/0345; A61G 15/12; A47C 7/50

(57) ABSTRACT

A mechanical stretching device for automatically folding a movable sofa leg includes a mechanical stretching device, a switching device, and an automatic folding device. The switching device includes a handle ring (1), a handle shank (3), a handle support (6) and a handle spring (5). The automatic folding device includes an automatic rotating part (8), a rotating tube (21), a spring hanging piece (17), folding spring (10). The handle ring (1) is rotatably connected to the handle shank (3). Handle shank (3) is rotatably connected to the handle support (6). The handle support (6) is fixed on the base frame mounting plate (20). The rotating tube (21) is rotatably connected to the base frame mounting plate (20). The automatic rotating part (8) is fixed on the rotating tube (21). The spring hanging piece (17) is rotatably connected to the automatic rotating part (8).

### CROSS REFERENCE TO RELATED APPLICATIONS

This application is the national, phase of International Application No. PCT/CN2015/087640, filed on Aug. 20, 2015, which is based upon and claims priority to Chinese Patent Application No. 2014104450638, filed on Sep. 3, 2014 the entire contents of which are incorporated herein by reference.

### TECHNICAL FIELD

The present invention relates to a mechanical stretching device for automatically folding a movable sofa leg, particularly, to a multifunctional mechanical stretching device for automatically folding a movable sofa leg where the leg can be automatically folded when the leg is at a certain angle, and the inclining angle of the seat back can be adjusted.

### BACKGROUND

Nowadays, the (manual) mechanical stretching device of the movable sofa in the prior art involves two significant defects. 1, The folding of the leg of the movable sofa needs a lot of force to complete when the folding approaches the final point. Usually, it would be difficult for the elders, children, or women to successfully fold the leg portion. 2, The self-locking of the folded leg of the movable sofa is not good enough. When the movable sofa undergoes a collision, there is a risk that the leg may unfold automatically.

### SUMMARY

### Technical Problem

The technical problem to be solved by the present invention is to overcome the above defects in the prior art and to provide a mechanical stretching device of the movable sofa, which is characterized by simple structure, safety, reliability, and an automatically foldable leg.

### Solution to the Problem

### Technical Solution

The technical solution employed by the present invention to solve the above technical problems is as below. A mechanical stretching device for automatically folding a movable sofa leg includes a mechanical stretching device. The mechanical stretching device has a left part and a right part that are the same. The left part and the right part are fixedly connected to each other through a fixing part. The mechanical stretching device is further provided with a switching device, an automatic folding device. The switching device includes a handle ring, a handle shank, a handle support, and a handle spring. The automatic folding device includes an automatic rotating part, a rotating tube, a spring hanging piece, and a folding spring. The handle ring is rotatably connected to the handle through the first rotating shaft. The handle is rotatably connected to the handle support through the second rotating shaft. The handle support is fixed on the base frame mounting plate. The rotating tube is rotatably connected to the base frame mounting plate through the fourth rotating shaft. The automatic rotating part is fixed on the rotating tube. The spring hanging piece is rotatably connected to the automatic rotating part through the third rotating shaft. The first spring nail is fixed on the base frame mounting plate. The second spring nail is fixed on the handle. The third spring nail is fixed on the base frame mounting plate. The fourth spring nail is fixed on the spring hanging piece. The handle spring is mounted between the first spring nail and the second spring nail. The folding spring is mounted between the third spring nail and the fourth spring nail. The handle shank is provided with the first limiting surface and the first limiting pin. The automatic rotating part is provided with the second limiting surface. The handle support is provided with the second limiting pin. The first limiting pin and the second limiting surface fit with each other to form a position restriction. The second limiting pin and the first limiting surface fit with each other to form a position restriction.

In the present invention, when the angle between the direction of the force generated by the folding spring and the horizontal line is less than the angle between the connecting line of the third rotating shaft and the fourth rotating shaft and the horizontal line, the force generated by the folding spring forces the leg of the mechanical stretching device to fold. When the angle between the direction of the force generated by the folding spring and the horizontal line is greater than the angle between the connecting line of the third rotating shaft and the fourth rotating shall and the horizontal line, the force generated by the folding spring makes the leg of the mechanical stretching device unfold. Such function makes the folding spring assist the unfolding or the folding of the mechanical stretching device so as to well realize the function of the mechanical stretching device.

In the present invention, the handle ring, the handle shank, the handle support, and the handle spring compose the switching device, such that the unfolding of the leg can be achieved. The handle shank can be completely hidden inside the sofa base frame so as to improve the aesthetic property of the sofa.

### Beneficial Effects of the Invention

### Beneficial Effects

The present invention solves the problem that the lee of the movable sofa is difficult to be folded or unfolded. Also, the leg can be automatically (or with assistance) unfolded or folded at a certain angle.

The present invention solves the problem that the leg of the movable sofa may automatically unfold after collision. Thus, the safety of the movable sofa is improved.

### BRIEF DESCRIPTION OF THE DRAWINGS

FIG. 1 is a front schematic diagram in which the left part or the right part of the leg is completely folded in an embodiment of the present invention.

FIG. 2 is a front schematic diagram showing the critical point between the automatically folding and unfolding in the embodiment of the present invention.

FIG. 3 is a front schematic diagram in which the left part or the right part of the leg is completely stretched (unfolded) in the embodiment of the present invention.

In the drawings: 1—handle ring; 2—the first rotating shaft; 3—handle shank; 4—the first spring nail; 5—handle spring; 6—the handle support; 7—the second spring nail; 8—automatic rotating part; 9—the first limiting pin; 10—folding spring; 11—the third spring nail; 12—the second limiting pin; 13—the first limiting surface; 14—the second rotating shaft; 15—the third rotating shaft; 16—the fourth rotating shaft; 17—spring hanging piece; 18—the fourth spring mil; 19—the second limiting surface; 20—base frame mounting plate; 21—rotating (rectangular) tube.

### DETAILED DESCRIPTION

The present invention is further described with reference to the drawings and the embodiments hereinafter.

In the embodiment of the present invention, a mechanical stretching device for automatically folding a movable sofa leg includes a switch device and an automatic folding device. The mechanical stretching device is the prior art. The mechanical stretching device has a left part and a right part that are the same. The left part and the right part are fixedly connected to each other through a fixing part. For example, the mechanical stretching device is disclosed in the patent document with the patent number of 200920200532.4, the patent publication document with the publication number of 102657449A, and the patent document with the patent number of 201220668439.8. As a particular example, each of the left part and the right part of the mechanical stretching device is provided with automatic rotating part 8, spring hanging piece 17, rotating tube 21, and folding spring 10. Rotating tube 21 is rotatably connected to base frame mounting plate 20 through the fourth rotating shaft 16. Automatic rotating part 8 is fixed on rotating tube 21 Spring hanging piece 17 is rotatably connected to automatic rotating part 8 through third rotating shaft 15. Third spring nail 11 is fixed on base frame mounting plate 20. Fourth spring nail 18 is fixed on base frame mounting plate 20. Folding spring 10 is mounted between third spring nail 11 and fourth spring nail 18. The left part or the right part is mounted with handle ring 1, handle shank 3, handle spring 5, and handle support 6. Handle ring 1 is rotatably connected to handle shank 3 through first rotating shaft 2. Handle shank 3 is rotatably connected to handle support 6 through second rotating shaft 14. Handle support 6 is fixed on base frame mounting plate 20. First spring nail 4 is fixed on base frame mounting plate 20. Second spring nail 7 is fixed on handle shank 3. Handle spring 5 is mounted between first spring nail 4 and second spring nail 7. The switching device of the mechanical stretching device is composed.

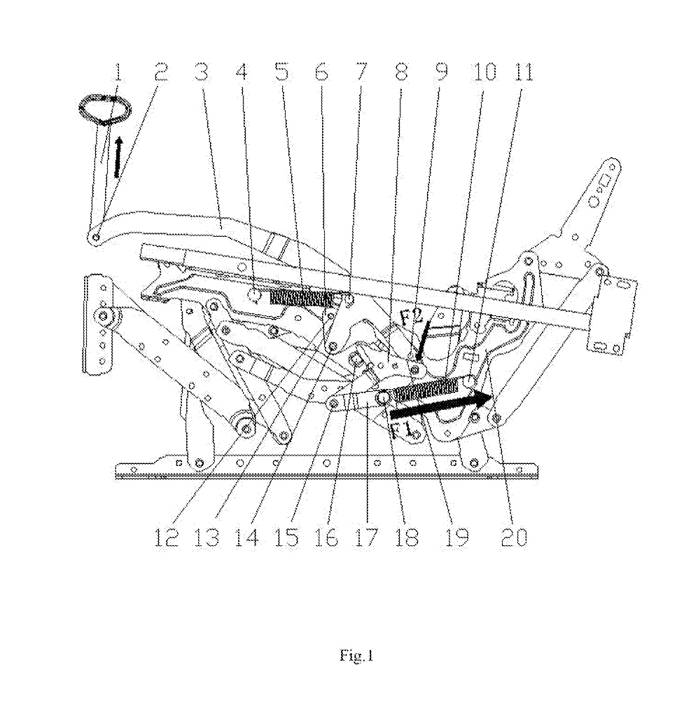

The design points of the embodiment of the present invention are the switching device and the automatic folding device. the switching device includes handle ring 1, handle shank 3, handle spring 5, and the handle support 6. When the user simply pulls handle ring 1 in the direction as shown in FIG. 1, handle shank 3 which is rotatably connected to handle support 6 through the second rotating shaft 14 is driven to move such that pressure F2 is generated by first limiting pin 9 fixed on handle shank 3 as shown in FIG. 1. As a result, automatic rotating part 8 fixed on rotating tube 21 and rotatably connected to base frame mounting plate 20 through fourth rotating shaft 16 is driven to move such that the leg of the mechanical stretching device is unfolded. When the leg is unfolded, the user releases handle ring 1. Since first spring nail 4 is fixed on base frame mounting plate 20, second spring nail 7 is fixed on handle shank 3, and handle spring 5 is mounted between first spring nail 4 and second spring nail 7, handle spring 5 is elongated, and thus a spring force is generated to reset handle shank 3. When the first limiting surface 13 on handle shank 3 contacts the second limiting pin 12, handle shank 3 is reset in place.

### Industry Utility

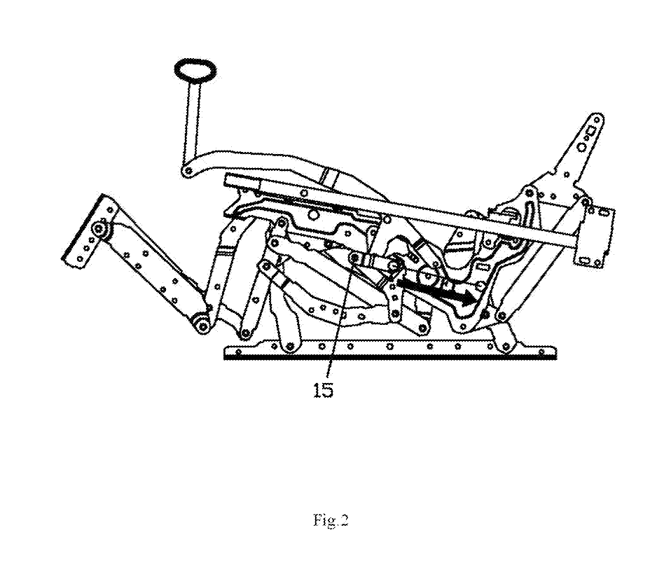

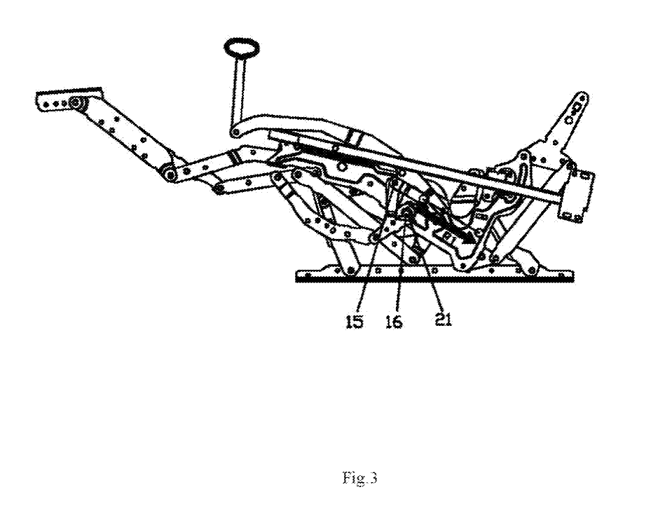

The automatic folding device includes automatic rotating part 8, spring hanging piece 17, rotating tube 21, folding spring 10. Rotating tube 21 is rotatably connected to base frame mounting plate 20 through fourth rotating shaft 16. Automatic rotating part 8 is fixed on rotating tube 21. Third spring nail 11 is fixed on base frame mounting plate 20. Fourth spring nail 18 is fixed on base frame mounting plate 20. Folding spring 10 is mounted between third spring nail 11 and fourth spring nail 18. When the direction of force F1 generated by folding spring 10 is the same as the direction of the connecting line of third rotating shaft 15 and fourth rotating shaft 16, the embodiment of the present invention is at the critical point between the folding and the unfolding (as shown in FIG. 2). When the direction of force F1 generated by folding spring 10 is below the direction of the connecting line of rotating shall 15 and fourth rotating shaft 16 (i.e., the angle between the direction of force F1 and the horizontal line is less than the angle between the horizontal line and the connecting line of third rotating shaft 15 and fourth rotating shaft 16, referring to the status of FIG. 1), the leg of the mechanical stretching device is forced to fold. The device moves in a manner from FIG. 2 to FIG. 1, i.e., the leg is automatically folded. When the direction of force F1 generated by folding spring 10 is above the direction of the connecting line of the third rotating shaft 15 and the fourth rotating shaft 16 (i.e., the angle between the direction of force F1 and the horizontal line is greater than the angle between the connecting line of third rotating shaft 15 and fourth rotating shaft 16 and the horizontal line, referring to the status of FIG. 3), the leg of the mechanical stretching device is forced to unfold. The device moves in a manner from FIG. 2 to FIG. 3, i.e., the leg is unfolded completely.

All the simple variations and equivalent alternations of the present invention should be conceived as falling within the scope of the present invention.

1. (canceled)

2. (canceled)

3. A mechanical stretching device for automatically folding a movable sofa leg, comprising:
a base frame mounting plate; and
a leg,
wherein
the mechanical stretching device for automatically folding a movable sofa leg further comprises an automatic folding device;
the automatic folding device comprises an automatic rotating part, a rotating tube, an elastic element hanging piece, and an elastic element;
the rotating tube is rotatably connected to the base frame mounting plate through a fourth rotating shaft;
the automatic rotating part is fixed on the rotating tube;
the elastic element hanging piece is rotatably connected to the automatic rotating part through a third rotating shaft;
the leg is connected to the automatic rotating part;
when an angle between a direction of a force generated by the elastic element and a horizontal line is less than an angle between the horizontal line and a connecting line of the third rotating shaft and the fourth rotating shaft, a force generated by the elastic element makes the leg to fold; and
when the angle between the direction of the force generated by the elastic element and the horizontal line is greater than the angle between the horizontal line and the connecting line of the third rotating shaft and the fourth rotating shaft, the force generated by the elastic element makes the leg to unfold.

4. The mechanical stretching device for automatically folding a movable sofa leg according to claim 3, further comprising a switching device, wherein the switch device includes a handle ring, a handle shank, a handle support, and a handle spring;
the handle ring is rotatably connected to the handle shank through a first rotating shaft;
the handle shank is rotatably connected to the handle support through a second rotating shaft; and
the handle support is fixed on a base frame mounting plate.

5. The mechanical stretching device for automatically folding a movable sofa leg according to claim 4, wherein
a first spring nail is fixed on the base frame mounting plate;
the switch device further includes a second spring nail;
the second spring nail is fixed on the handle shank; and
the handle spring is mounted between the first spring nail and the second banking nail.

6. The mechanical stretching device for automatically folding a movable sofa leg according to claim 4, wherein
the handle shank is provided with a first limiting surface and a first limiting pin;
the automatic rotating part is provided with a second limiting surface;
the handle support is provided with a second limiting pin;
the first limiting pin matches the second limiting surface; and
the second limiting pin matches the first limiting surface.

7. The mechanical stretching device for automatically folding a movable sofa leg according to claim 3, wherein the elastic element is a folding spring.

8. The mechanical stretching device for automatically folding a movable sofa leg according to claim 7, wherein,
a third spring nail is fixed on the base frame mounting plate;
the automatic folding device further comprises a fourth spring nail;
the fourth spring nail is fixed on the elastic element hanging piece; and
the folding spring is mounted between the third spring nail and the fourth spring nail.
